(19) United States
(12) Patent Application Publication
(10) Pub. No.: US 2008/0243565 A1
(43) Pub. Date: Oct. 2, 2008

(54) Method and Computer Software for Integrating Systems Engineering and Project Management Tools

(75) Inventor: Mark Alexander Gregory, North Melbourne (AU)

Correspondence Address: SEED INTELLECTUAL PROPERTY LAW GROUP PLLC, 701 FIFTH AVE, SUITE 5400, SEATTLE, WA, 98104, US

(73) Assignee: Pipercove Software Pty Ltd, Noth Melbourne (AU)

(21) Appl. No.: 10/594,831

(22) PCT Filed: Jan. 18, 2005
(86) PCT No.: PCT/AU2005/000054

§ 371 Date: Jun. 12, 2008

(30) Foreign Application Priority Data
Apr. 1, 2004 (AU) 2004901743

(51) Int. Cl. G06Q 10/00

(52) U.S. Cl. 705/7; 705/1

(57) ABSTRACT

A method (200) for integrating systems engineering (102) and project management tools (104), the method (200) including the steps of: obtaining component parts and life cycle activities of a system (202); creating a system information model by selectively and individually linking parts and activities with tasks, resources, time and costs (204); updating the system information model by selectively and individually adding or modifying parts, activities, tasks, resources, time, costs and links therebetween (206); storing versions of the system information model (208); processing versions of the systems information model into end-user information to enable life cycle analysis of the system (210).

### FIELD OF THE INVENTION

The present invention relates to systems engineering and project management and, more particularly, to a method and computer software for integrating systems engineering and project management tools to optimise the development and management of large, complex systems over extended life cycles.

### BACKGROUND OF THE INVENTION

Systems engineering is a holistic approach used to derive, evolve and verify a life cycle balanced system solution that satisfies customer expectations and meets public acceptability and accountability. Project management is a narrower approach used to schedule tasks based on time and resources. When used together, systems engineering and project management processes can optimise the development and management of large, complex systems over extended life cycles.

A critical practical barrier to combining systems engineering and project management processes is the lack of integrated software tools. Software applications have become widely used tools in project management. However, project management applications are incapable of processing the complex overall interrelationships between parts and activities of a system as it evolves over a life cycle. For example, project management applications cannot provide traceability of engineering and management decisions made between the analysis, design, implementation and operation stages in the development of a large, technically complex system.

It is therefore highly desirable to seamlessly add systems engineering capabilities into project management software to thereby provide engineers and project managers with an integrated set of tools for total-cycle management of large, complex systems.

### SUMMARY OF THE INVENTION

According to the present invention, there is provided a method for integrating systems engineering and project management tools, the method including the steps of:
obtaining component parts and life cycle activities of a system;
creating a system information model by selectively and individually linking parts and activities with tasks, resources, time and costs;
updating the system information model by selectively and individually adding or modifying parts, activities, tasks, resources, time, costs and links therebetween;
storing versions of the system information model;
processing versions of the system information model into end-user information to enable life cycle analysis of the system.

The present invention also provides computer software for integrating systems engineering and project management tools, the computer software residing on a computer-readable medium and including instructions for causing a computer to perform the following operations:
obtain component parts and life cycle activities of a system;
create a system information model by selectively and individually linking parts and activities with tasks, resources, time and costs;
update the system information model by selectively and individually adding or modifying parts, activities, tasks, resources, time, costs and links therebetween;
store versions of the system information model;
process versions of the system information model into end-user information to enable life cycle analysis of the system.

The method and computer software of the present invention are preferably implemented as an add-in (or plug-in) to a project management application, such as Microsoft Project™, Artemis® and Primavera®. Preferably, the system information model accesses tasks, resources, time and costs from the project management application.

The system information model preferably includes at least one of parts, activities, tasks, resources, time, costs and phases relating to at least one of the requirements, definition, design, development, manufacturing, testing, deployment, operating, support, environmental impact, sustainability and decommissioning of the system.

Preferably, the system information model and the end-user information are created and manipulated using libraries and templates. The libraries and the templates are preferably stored in files or a relational database, such as Microsoft SQL Server™. The libraries preferably include information relating to component parts, tasks, resources and life cycle activities of systems. The templates are preferably expressed through standard notations, such as XML.

Preferably, processing versions of the system information model includes comparing different versions to provide traceability between iterations of the system over the life cycle.

The end-user information to enable analysis of the system over the life cycle may include information relating to at least one of systems engineering, project management, risk management, life cycle cost, life cycle assessment, environmental impact and system activities of the system project.

### BRIEF DESCRIPTION OF THE DRAWINGS

An embodiment of the present invention will now be described solely by way of non-limiting example and with reference to the accompanying drawings in which:

FIG. 1 is a block diagram of the integration of a systems engineering tool and a project management tool in an embodiment of the method of the present invention;

FIG. 2 is a flow diagram of a method for integrating systems engineering and project management tools, consistent with an embodiment of the present invention;

FIGS. 3a-3f are flow diagrams of the creation and manipulation of a system information model;

FIG. 4 is a flow diagram of the processing of the system information model into life cycle costing end-user information;

FIGS. 5a-5f are flow diagrams of the storing and traceability of different versions of the system information model;

FIGS. 6a and 6b are flow diagrams of the processing of the system information model into end-user information using information from the project management tool;

FIGS. 7a-7c are flow diagrams of the use of templates to create and manipulate the system information model and end-user information;

FIGS. 8a-8g are flow diagrams of the use of libraries to create and manipulate the system information model;

FIGS. 9a-9c are flow diagrams of the use of ToDo lists to manipulate the system information model and end-user information;

FIG. 10a-10d are flow diagrams of the use of user guides to create and manipulate the system information model;

FIGS. 11a-11l are sample screen shots of a systems engineering add-in to a project management application.

### DETAILED DESCRIPTION OF THE EMBODIMENTS

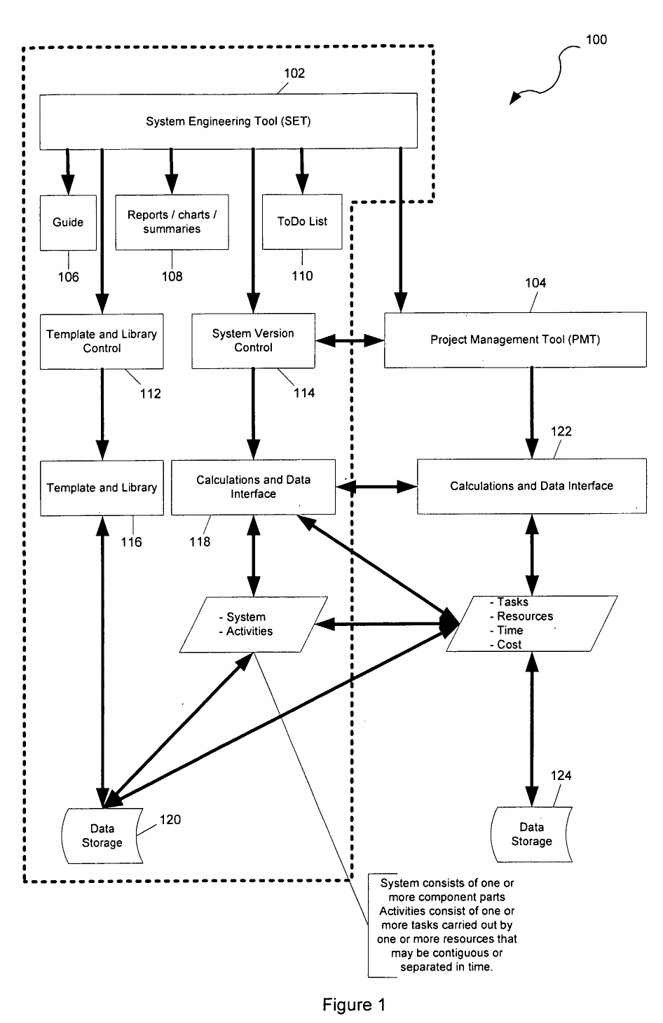

Referring to FIG. 1, an embodiment 100 of the invention is illustrated in which a systems engineering tool (SET) 102 is integrated with a project management tool (PMT) 104. In the illustrated embodiment, the PMT 104 is a commercially available project management application, such as Microsoft Project™, and the SET 102 is an add-in (or plug-in) to the PMT 104. Microsoft Project™ is a common PMT in use today by a large number of users in all countries of the world. Microsoft Project™ is a single user PMT that allows for collaboration through the storage of the underlying application data objects in a relational database, such as Microsoft SQL Server™. Microsoft Project™ users can be assigned roles with authorisation to carry out certain PMT tasks associated with manipulating the underlying data; this is a collaboration feature.

The SET 102 includes a guide module 106, a reports/charts/summaries module 108, a ToDo list module 110, a template and library control module 112, a system version control module 114, a template and library module 116, a calculation and data interface 118 and storage 120. The PMT 104 includes a calculation and data interface 122 and storage 124. The respective calculations and data interface modules 118, 122 of the SET 102 and the PMT 104 map and bi-directionally synchronise system parts and activities to tasks, resources, time and costs to create a system information model. Versions of the system information model are stored in the storage 120 of the SET 102. The respective functions of the modules of the SET 102 are described below with reference to flow diagrams.

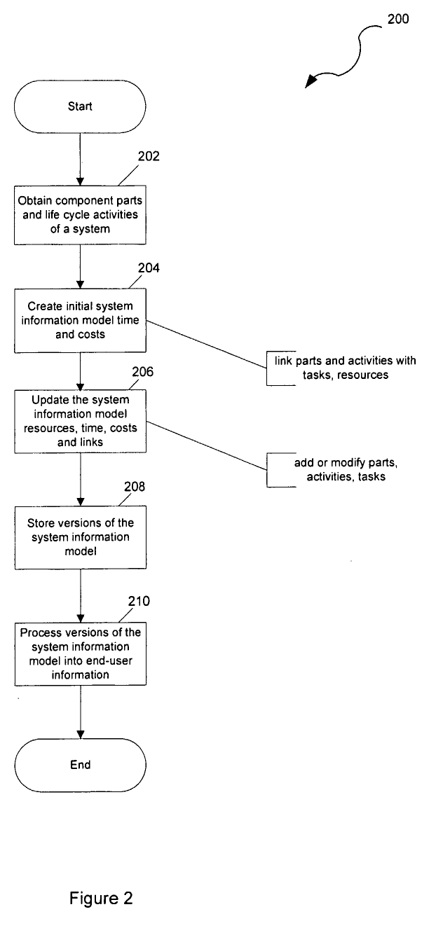

FIG. 2 is a flow diagram illustrating a general method 200 for integrating systems engineering and project management tools, consistent with an embodiment of the present invention. Although described serially, the flow points and method steps of the method 200 can be performed by separate elements in conjunction or in parallel, whether asynchronously or synchronously, in a pipelined manner, or otherwise. In the context of the invention, there is no particular requirement that the method must be performed in the same order in which this description lists flow points or method steps, except where explicitly so stated. Referring to FIG. 2, at step 202 information relating to component parts and life cycle activities of a system are obtained using the SET 102. An information model of the system is then created at step 204 by selectively and individually linking system parts and activities from the SET 102 with tasks, resources, time and costs from the PMT 104. The system information model is updated at step 206 by selectively and individually adding or modifying parts, activities, tasks, resources, time, costs and links therebetween. At step 208, versions of the system information model are stored in the storage 120 of the SET 102. In step 210, versions of the system information model are processed into end-user information by the calculation and data interface 118 of the SET 102 to enable life cycle analysis of the system.

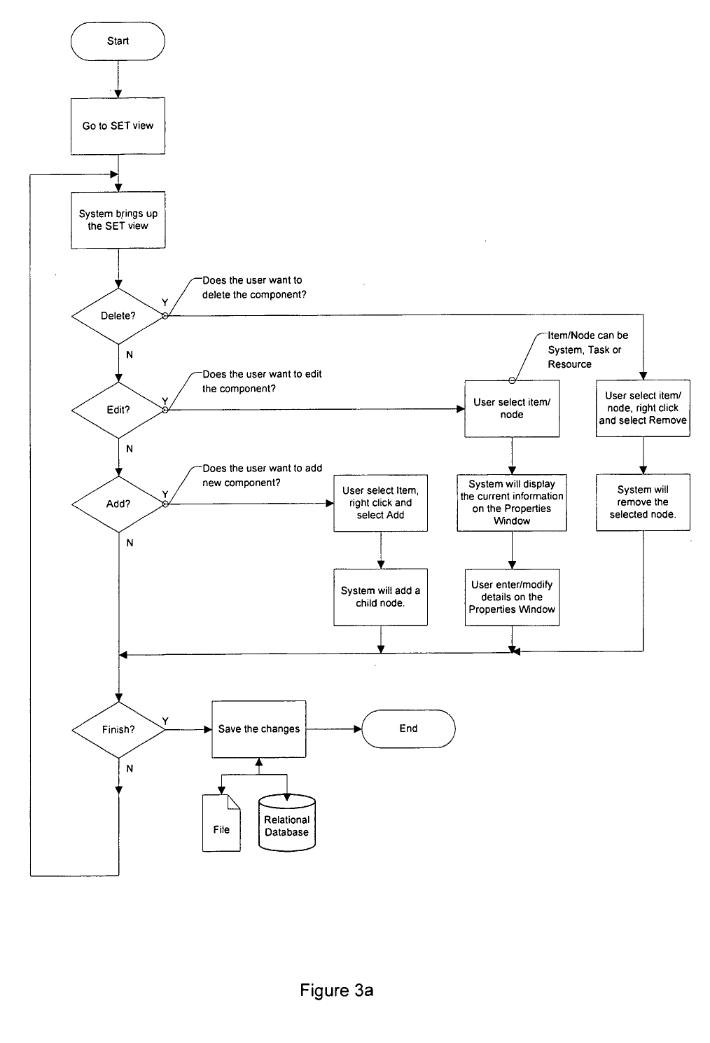

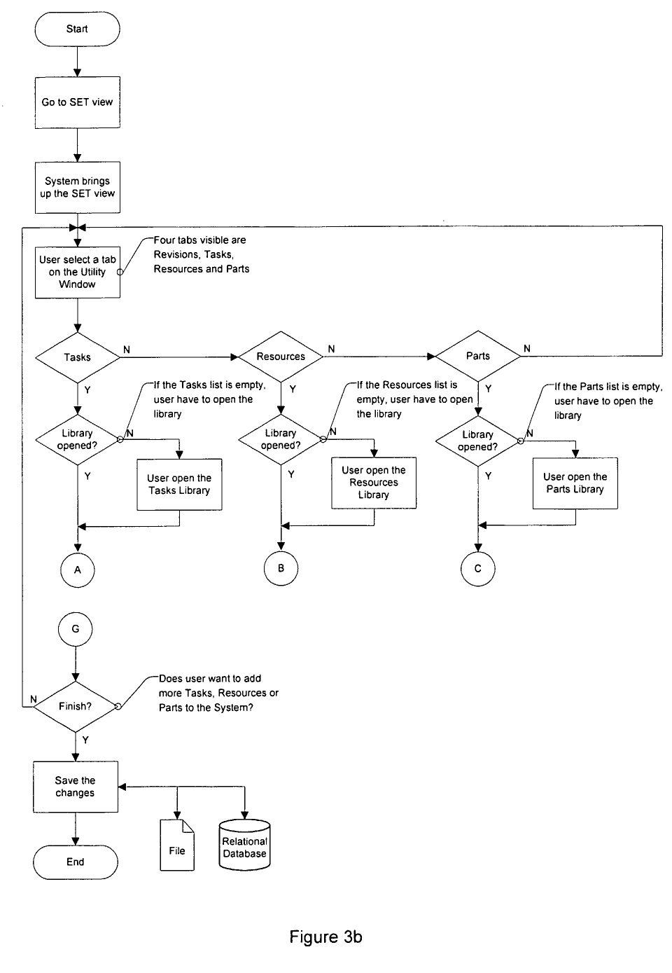

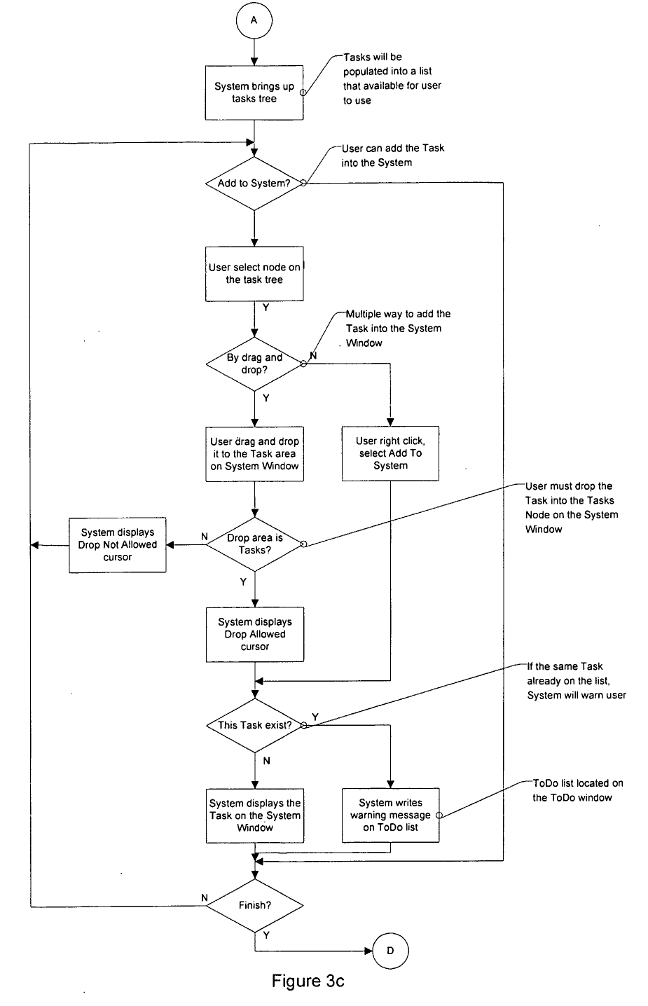

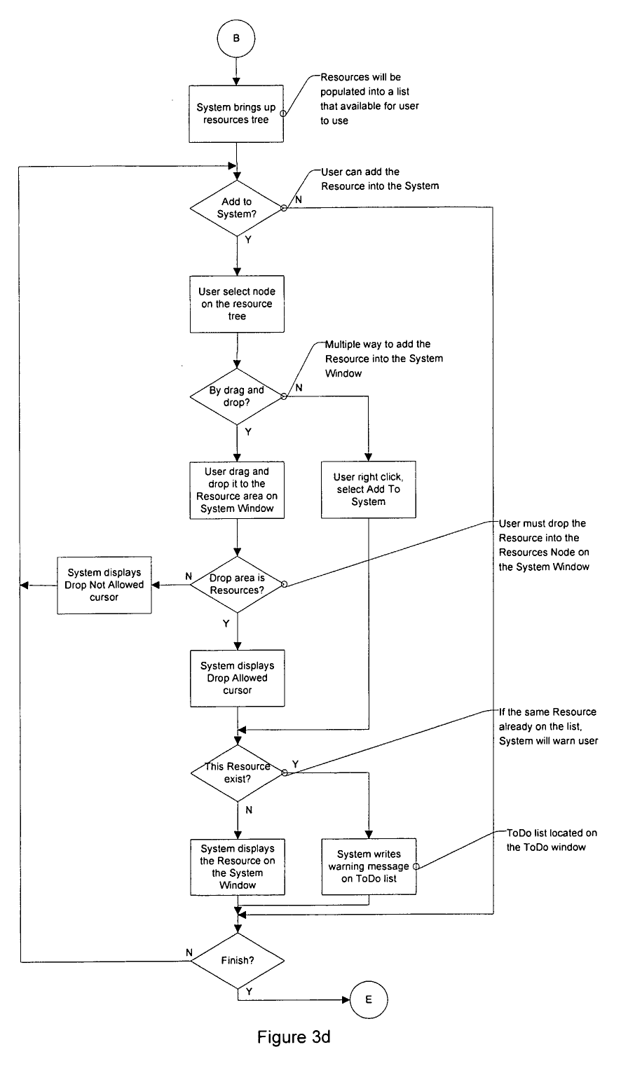

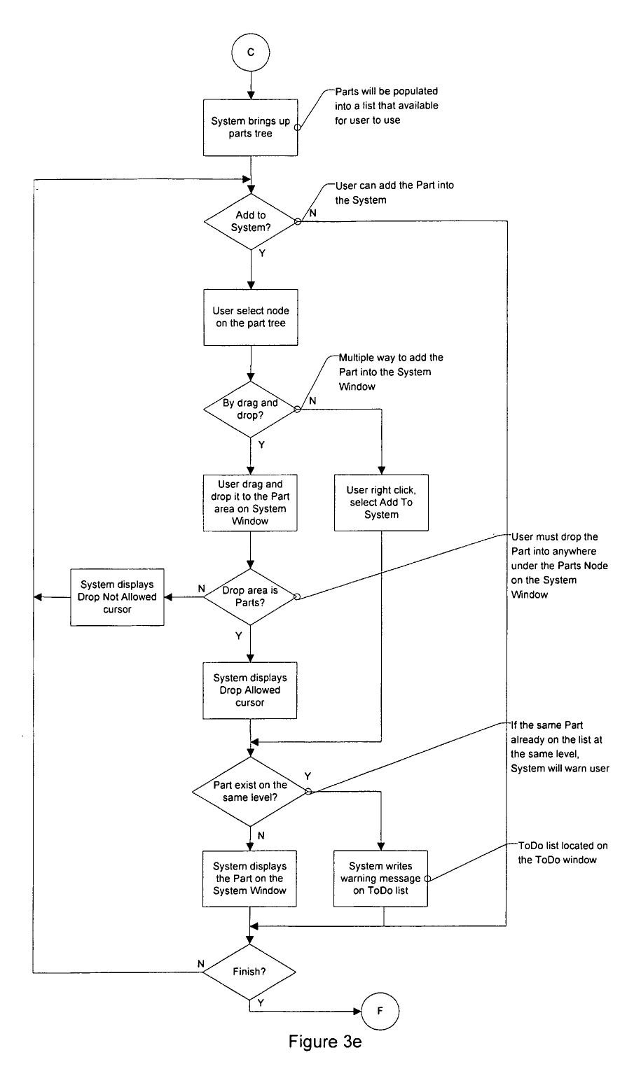

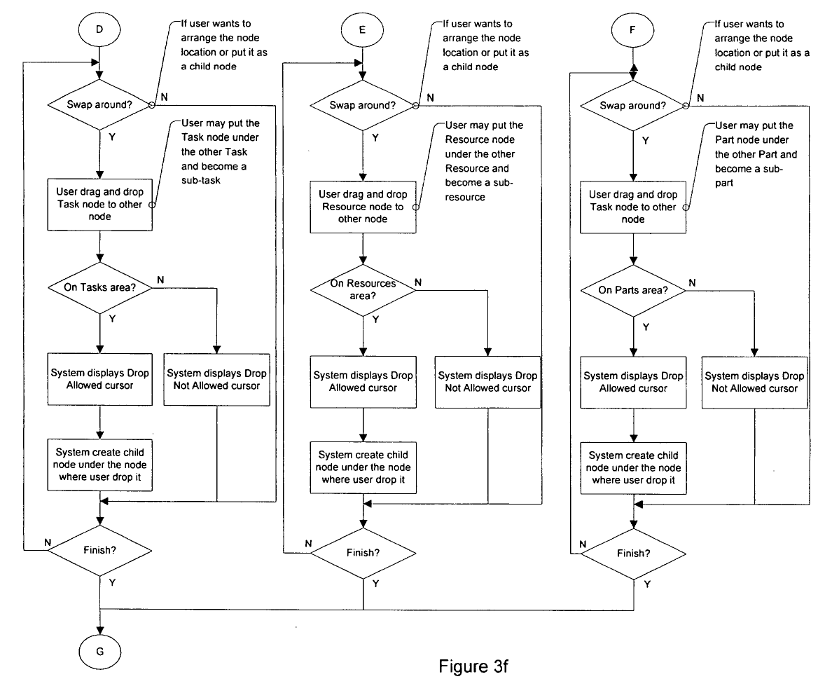

FIGS. 3a-3f illustrate the general flow of creating and manipulating a system information model using the SET 102. Referring to FIG. 3a, a system can be designed, created or constructed using system component parts, activities, tasks, and resources. Each of the component parts, activities, tasks, and resources constitute something that consists of time, cost, materiel and other numerical values such that the system information model as a whole can be analysed using calculations and reports produced from the SET 102. The system components can be added, deleted or changed. The SET 102 therefore provides an environment that simplifies the process of system design and analysis and works in conjunction with data objects that may be provided through the PMT 104.

As best seen in FIGS. 3b-3f, the SET 102 includes a system design capability using a structured approach that includes a hierarchical structure for elements that can include sub-elements and also provides for a flat relationship for elements that do not include sub-elements. For example, an element such as system deployment might contain sub-elements that are system deployment actions or, alternatively, an element such as system deployment might be an individual element that contains information about the system deployments for the life of the system or project and associated information such as the total number of systems deployed, how, cost, resources and other associated information.

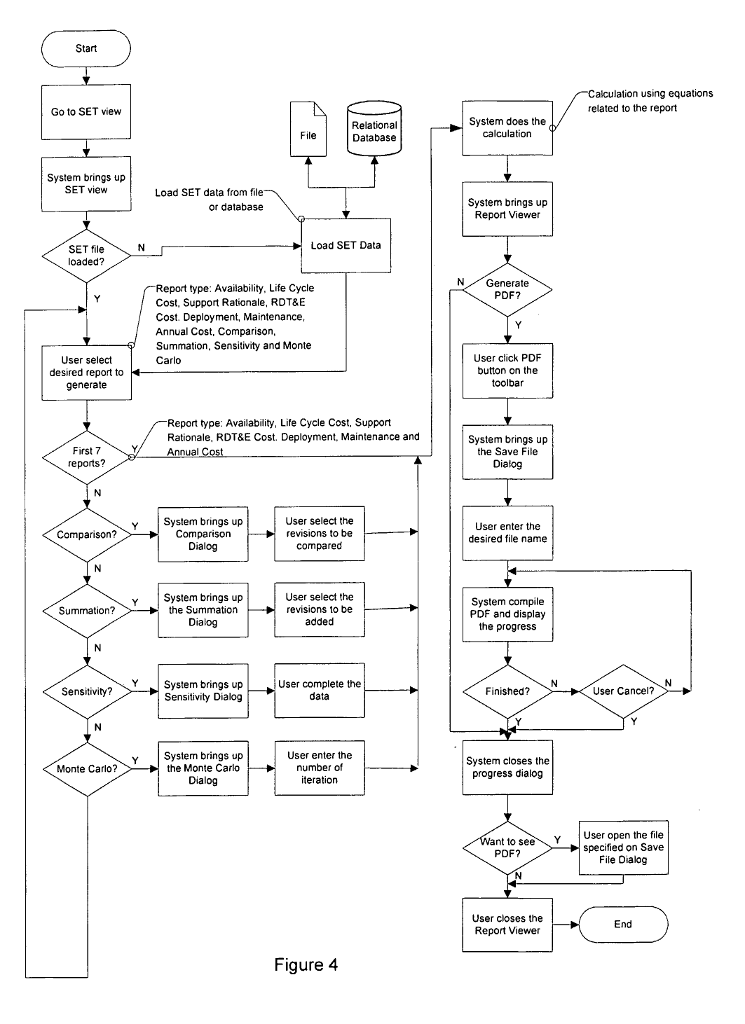

FIG. 4 illustrates the general flow of processing the system information model into end-user information to enable total-cycle analysis of the system. The system analysis capability provided by the calculations and data interface module 114 and the reports/charts/summaries module 108 of the SET 102 includes system analysis computations in the areas of systems engineering, risk management, life cycle costing, life cycle assessment and other areas under the general umbrella of systems engineering or analysis including automated decision intelligence.

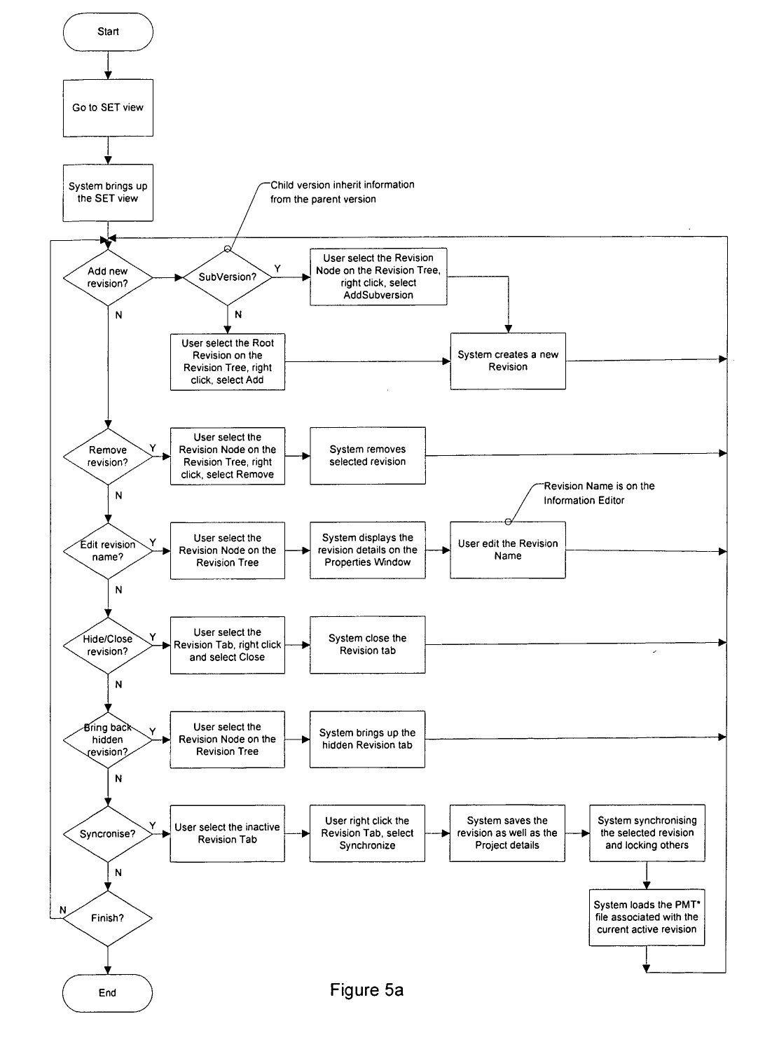

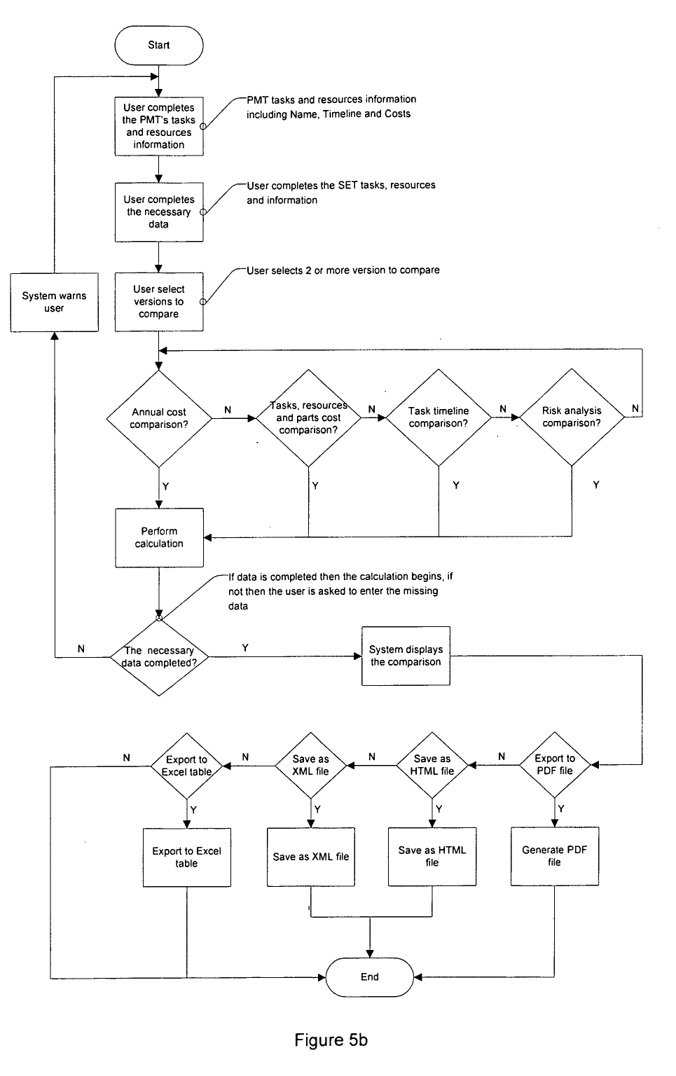

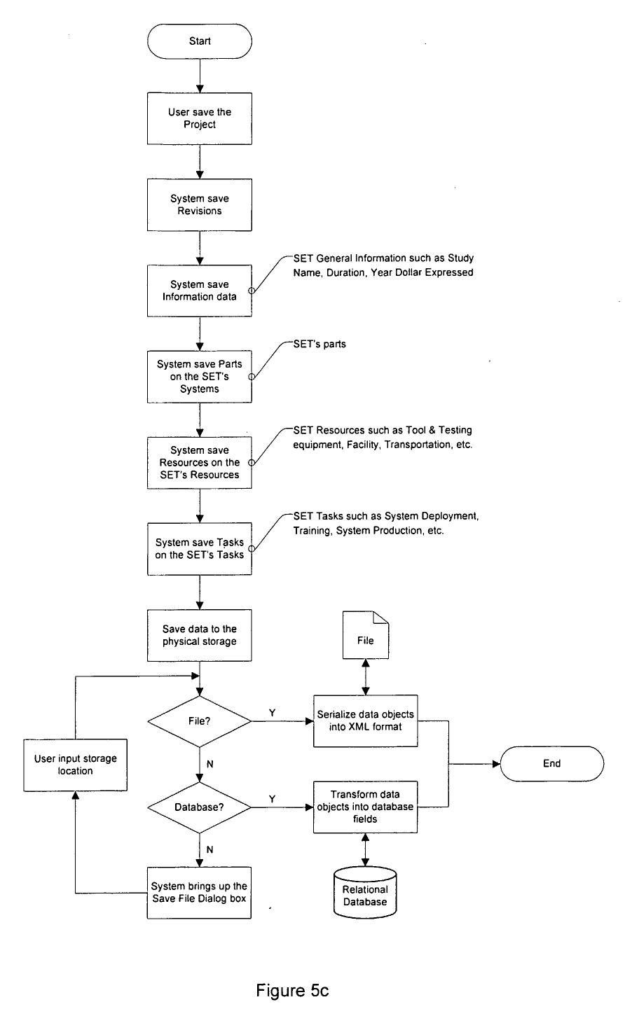

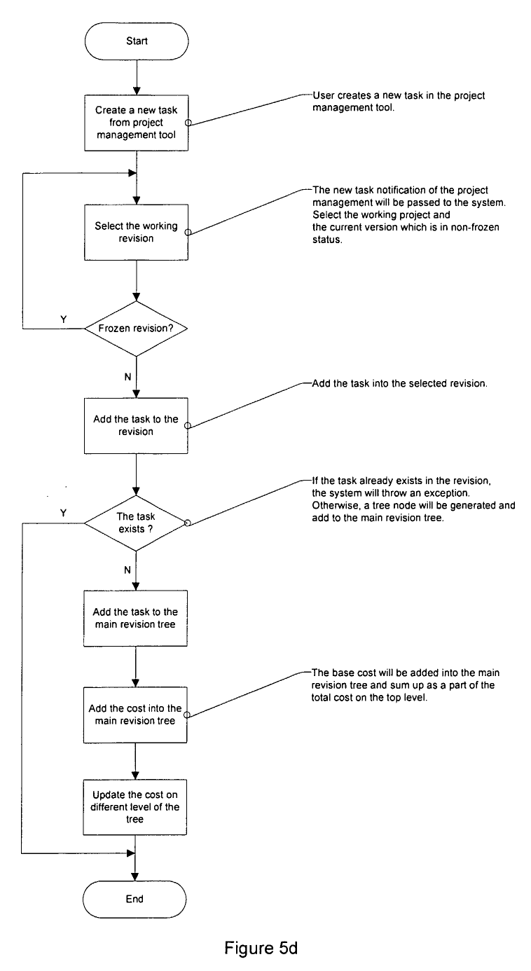

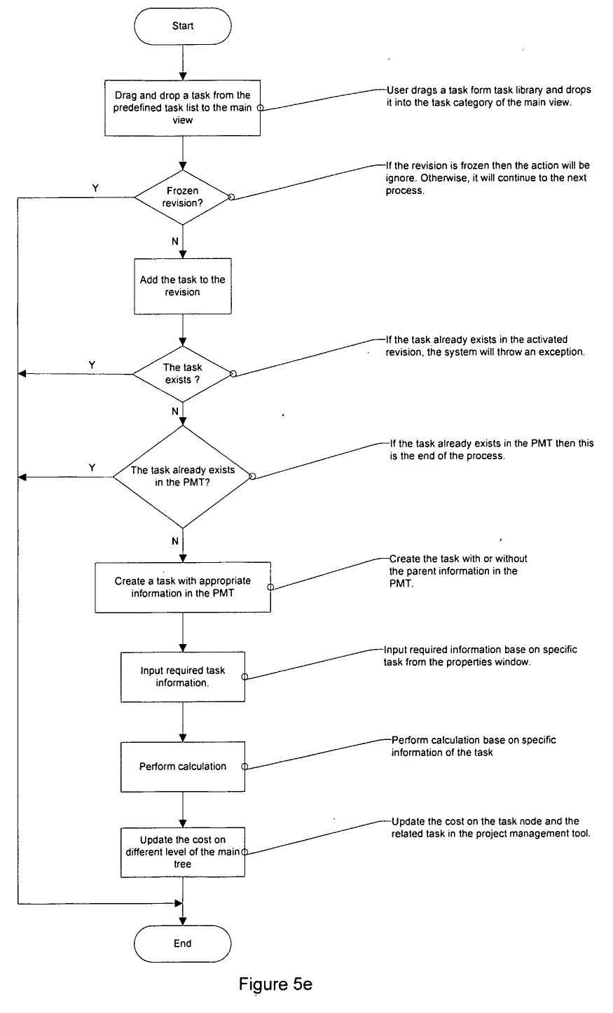

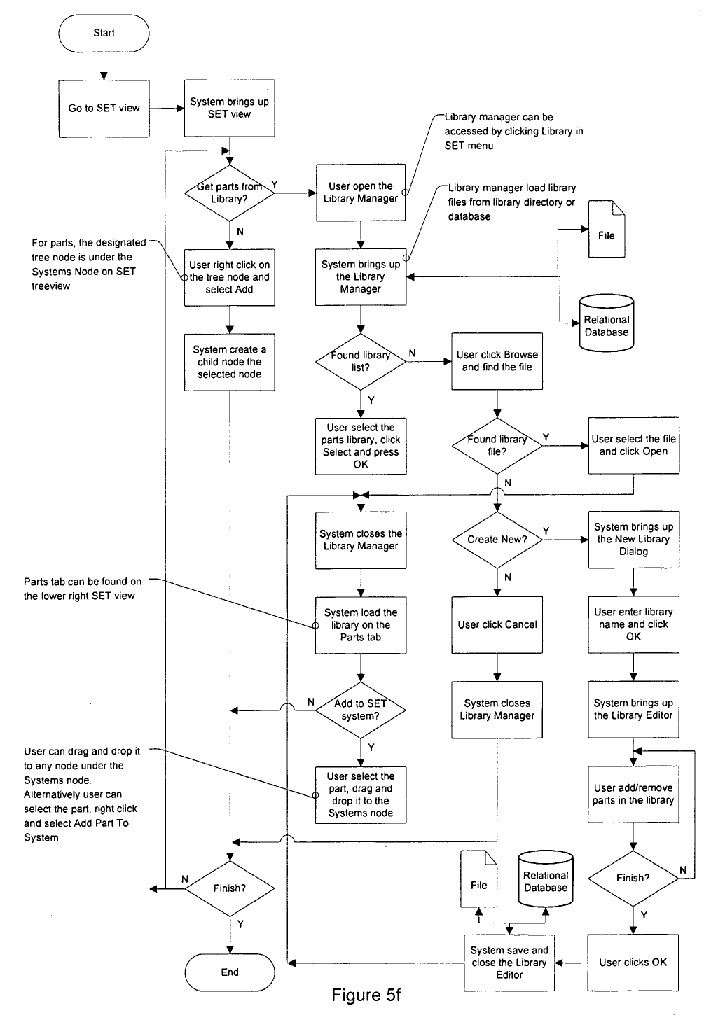

FIGS. 5a-5f illustrate the general flow of manipulating and storing versions of the system information model. The system version control module 114 of the SET 102 provides for versions of the system information model to be frozen, active and copies of either frozen or active versions, known as sub-versions (or revisions). A version of a system information model includes all of the information necessary to reconstitute the version if it was to be the active version. This includes all of the information necessary to alter the PMT 104 to reflect the active version. This provides the user with the capability to compare versions of the system information model and to carry out “what-if” scenarios using the SET 102 or PMT 104. The SET 102 includes versions, calculations and rule sets needed to carry out automated decision making. In addition, the SET 102 identifies to the user information that is needed by putting entries into a ToDo list. The ToDo list module 110 of the SET 102 ties the ToDo list item to the information which the user needs to provide, such that if the user points to a ToDo list item the SET 102 will display the missing information and highlight it ready for user input. The SET 102 further includes intelligence such that the rule sets and calculations can identify areas of risk and highlight these in reports. The rule sets and intelligence of the SET 102 will also predict outcomes such as for maintainability engineering spare parts, and repair personnel requirements and dispersal throughout the repair chain.

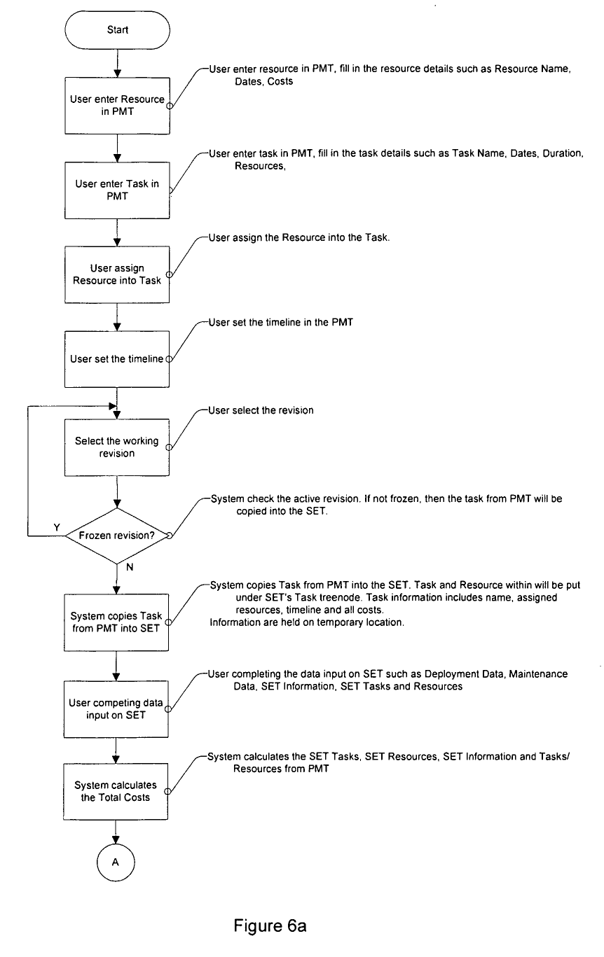

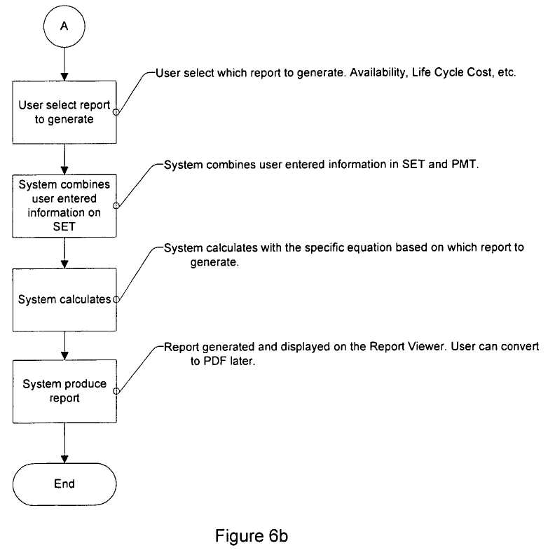

FIGS. 6a and 6b illustrate the general flow of accessing the PMT 104 using the calculations and data interface module 118 of the SET 102 to retrieve information from PMT data objects needed for calculations, intelligence and reporting.

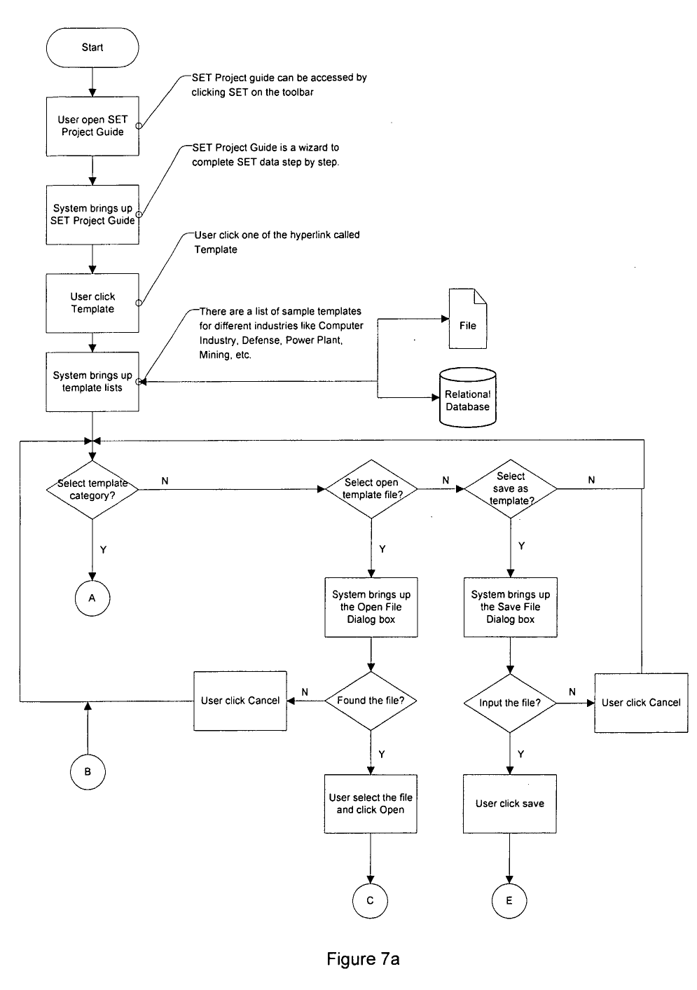

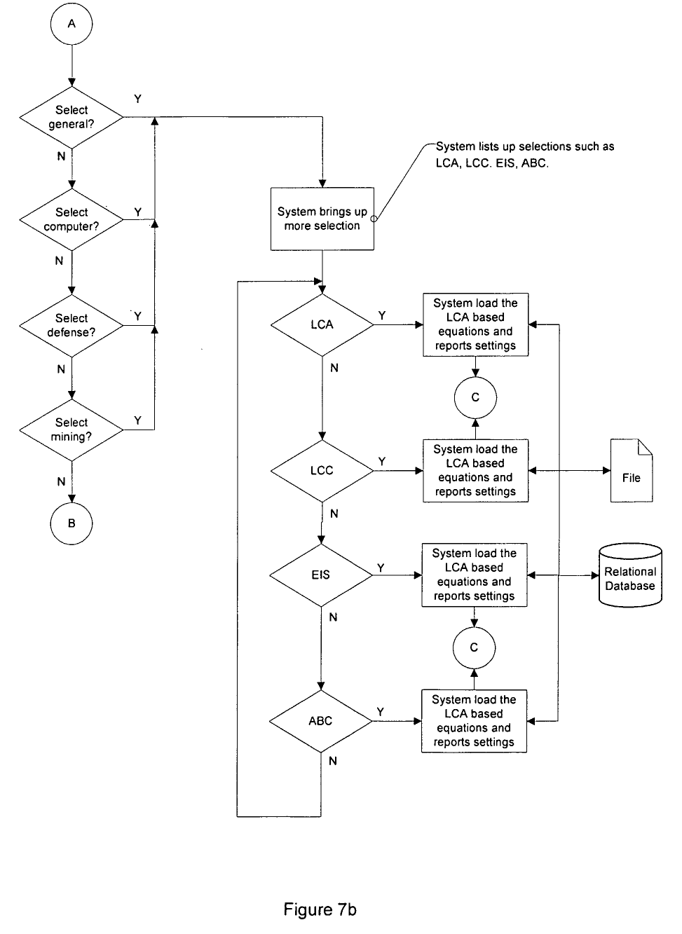

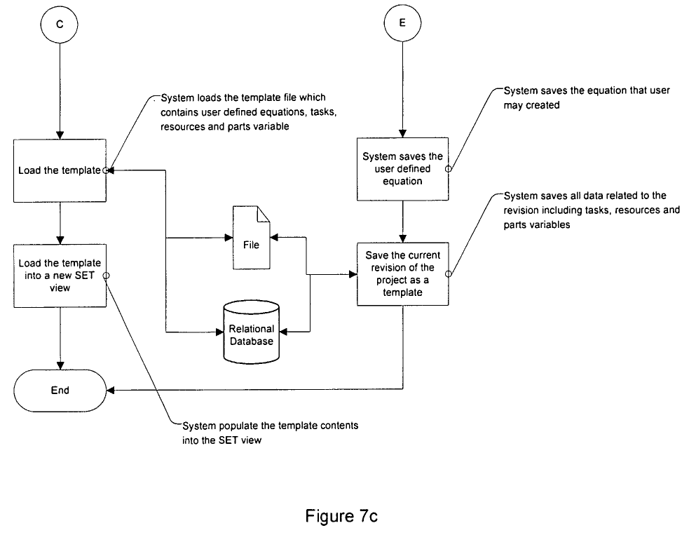

FIGS. 7a-7c illustrate the general flow of using templates to create and manipulate the system information model and end-user information. A template is a collection of intelligence, rule sets, calculations, libraries (including rule sets, calculations, activities, component parts, resources and tasks) that can be loaded from a menu by the user. The template and library control module 112 of the SET 102 provides a framework for templates to be created for most industries and services. The template and library module 116 of the SET 102 provides the user with a number of the templates by default, including systems engineering, risk management, life cycle costing, life cycle assessment and life cycle analysis, value engineering, activity based costing, environmental impact and other templates.

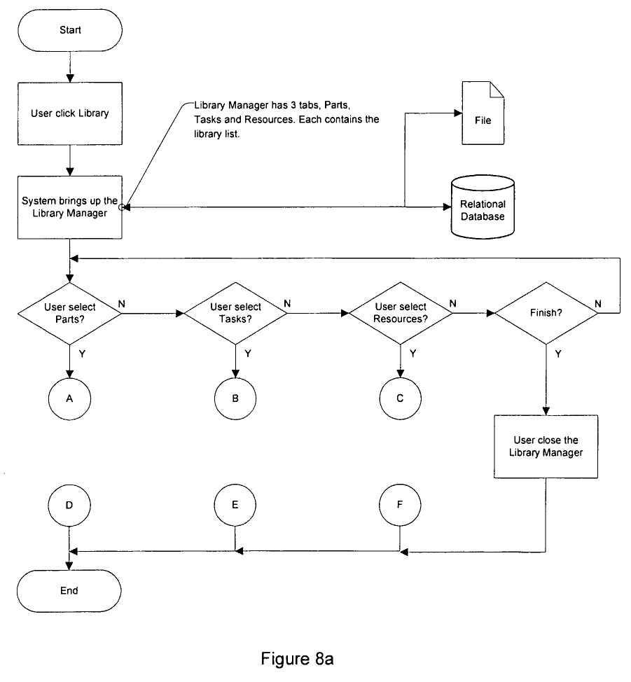

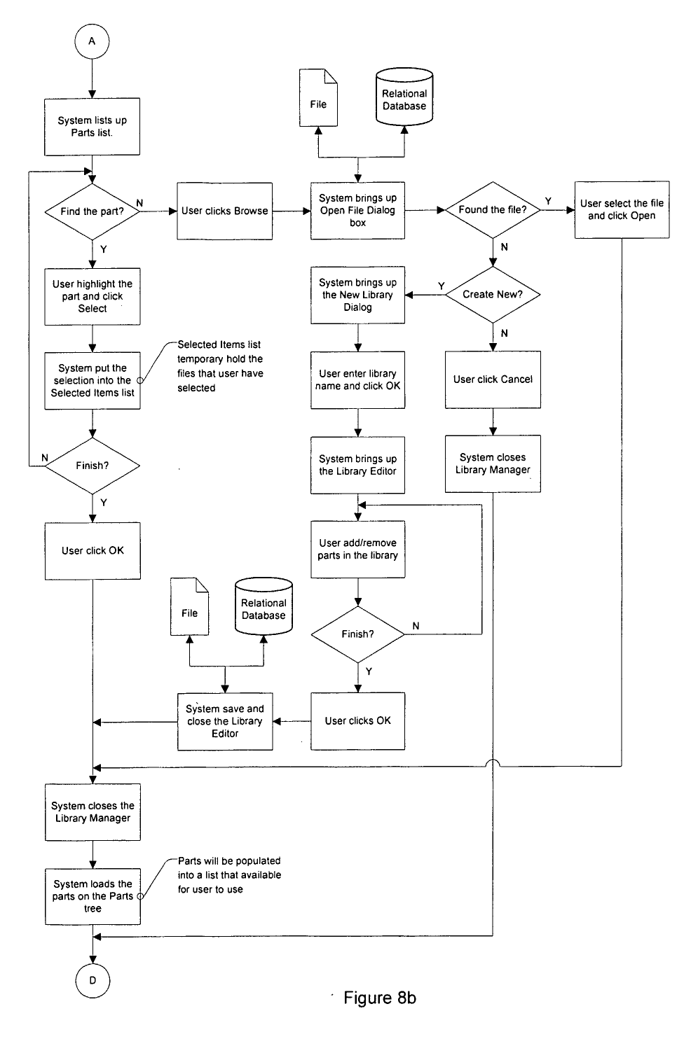

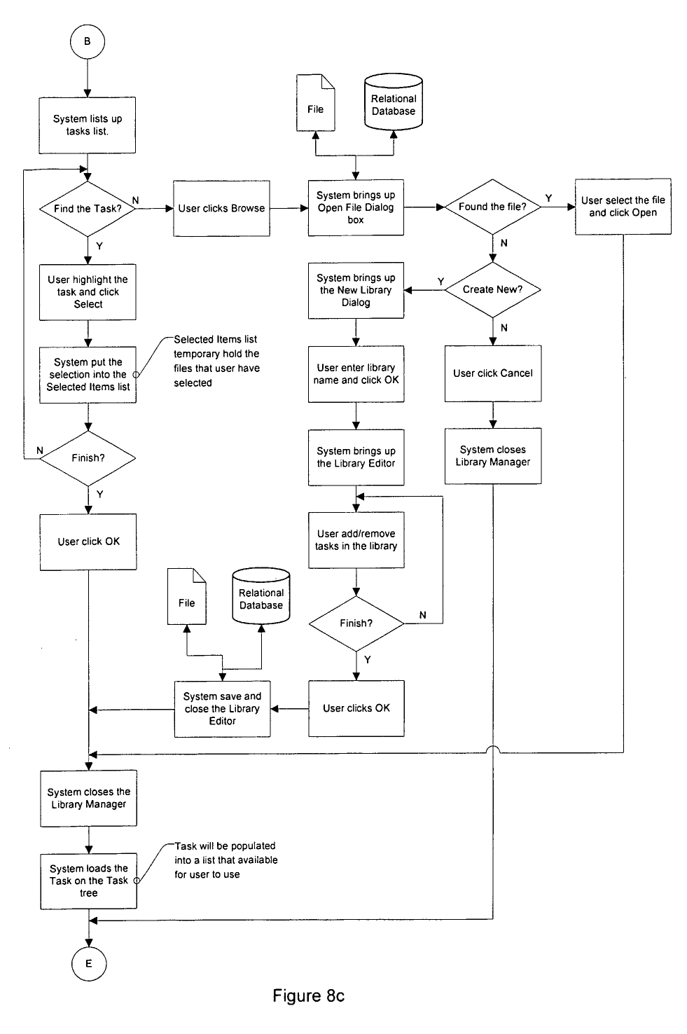

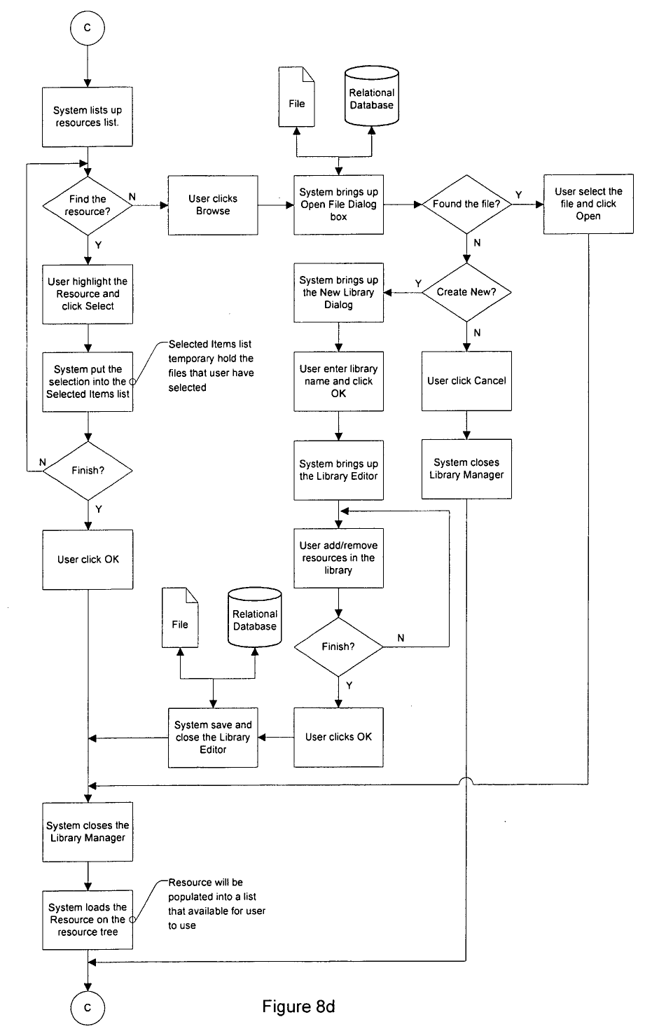

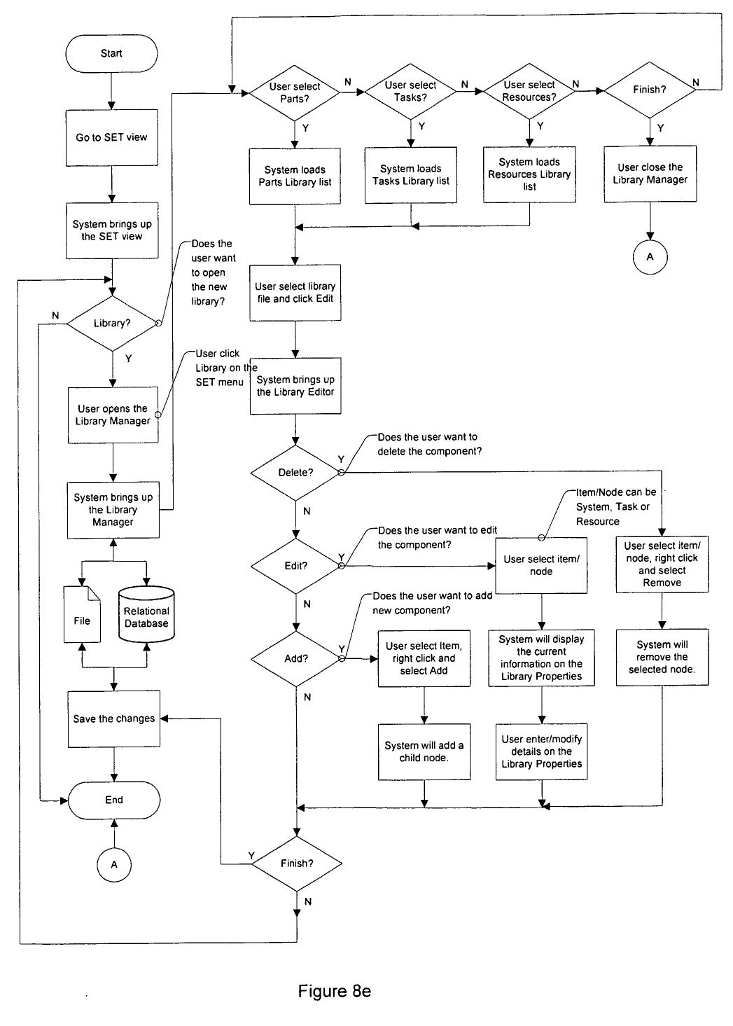

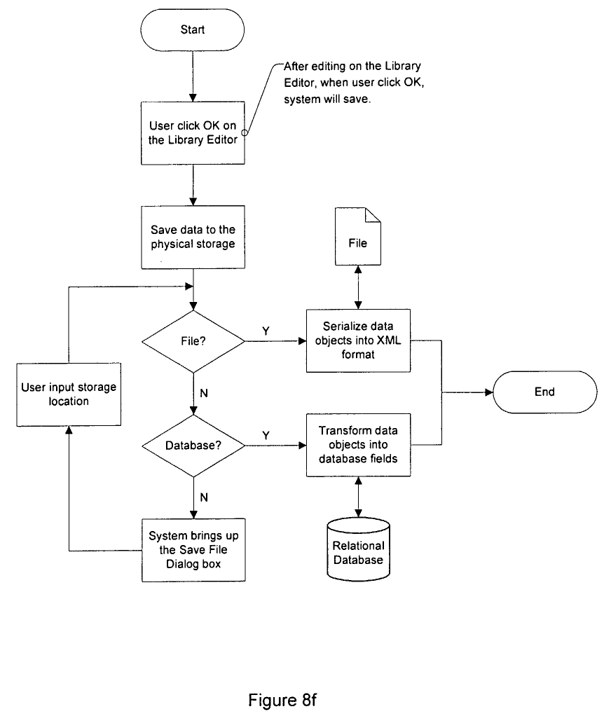

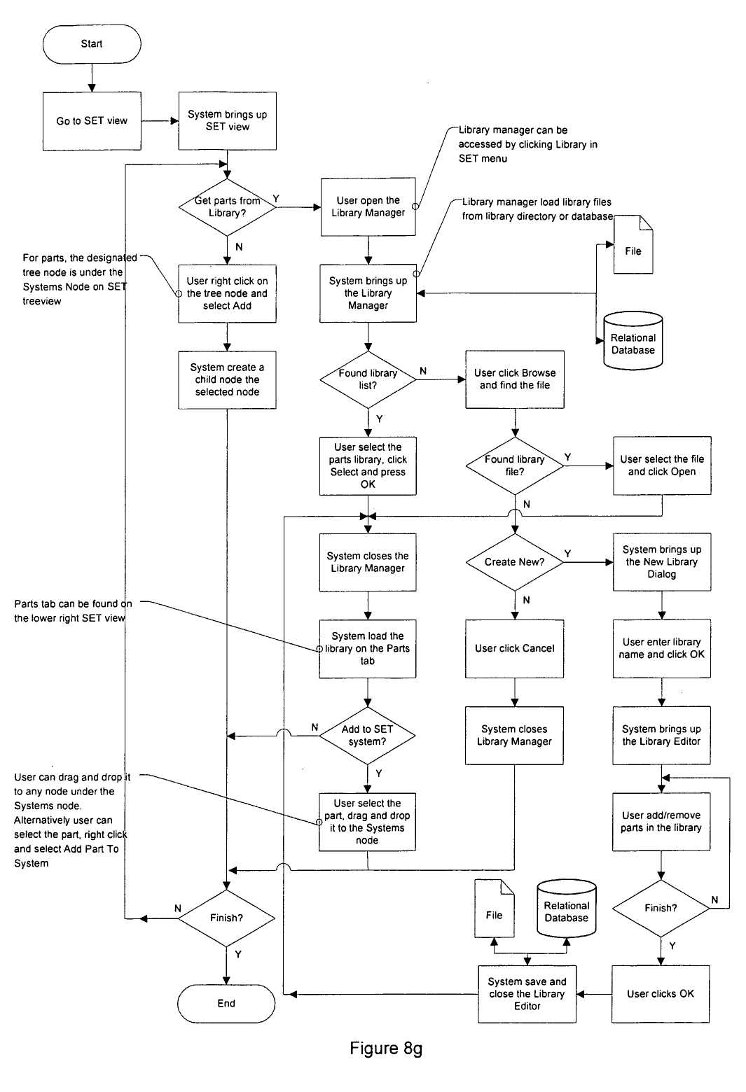

FIGS. 8a-8g illustrate the general flow of using libraries in the SET 102. Libraries can be opened from templates or individually and include calculations, rule sets, activities, component parts, tasks, and resources. Libraries can be modified by the user and items in the library can be added, deleted or changed. In addition, libraries can also be merged or split. Further, libraries can be stored and accessed from file or from relational databases.

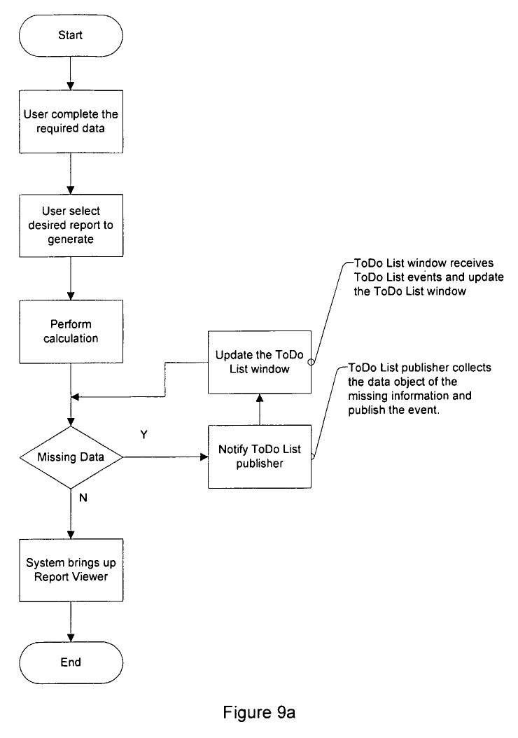

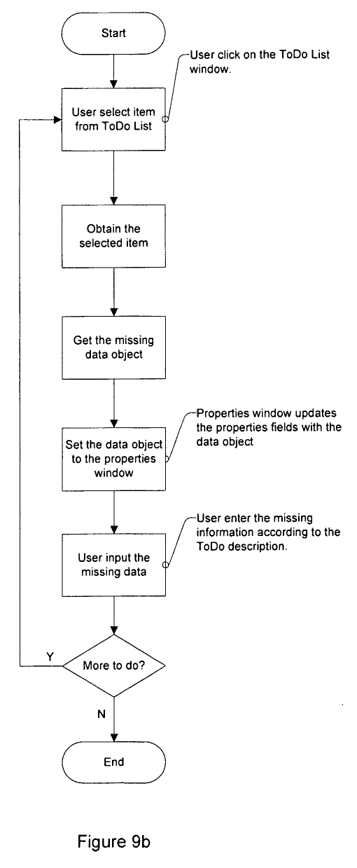

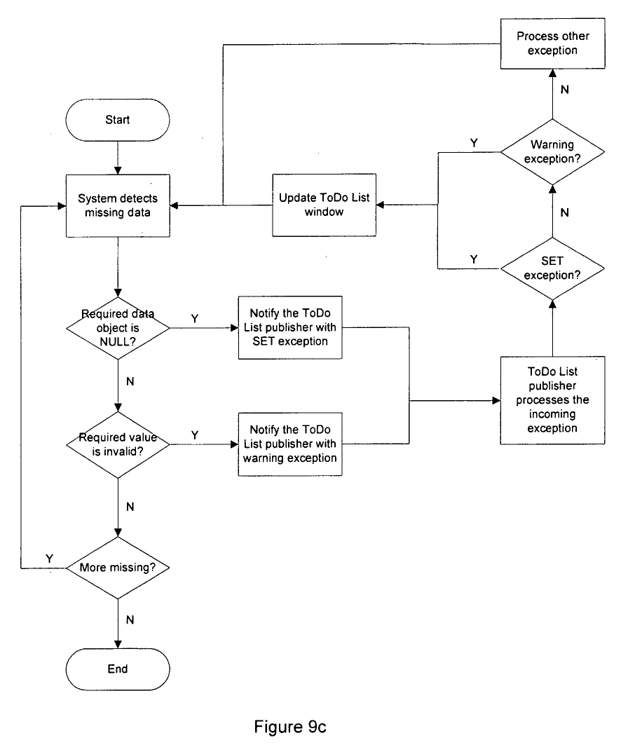

FIGS. 9a-9c illustrate the general flow of processing ToDo lists. The SET 102 includes intelligence through the inclusion of the ToDo list module 110. This module includes rule sets and intelligence so that the SET 102 can publish items requiring the user's attention, then when the user selects an item in the ToDo List, the SET 102 will display the property or other element that needs user input, usually in the form of new or changed values. The ToDo list is part of the intelligence capability of the SET 102.

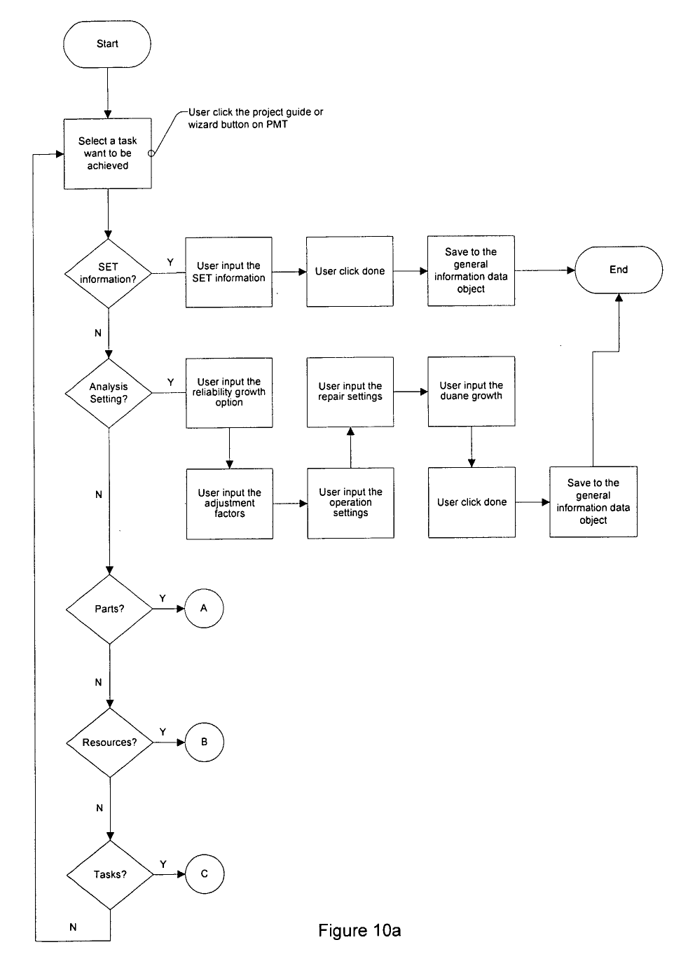

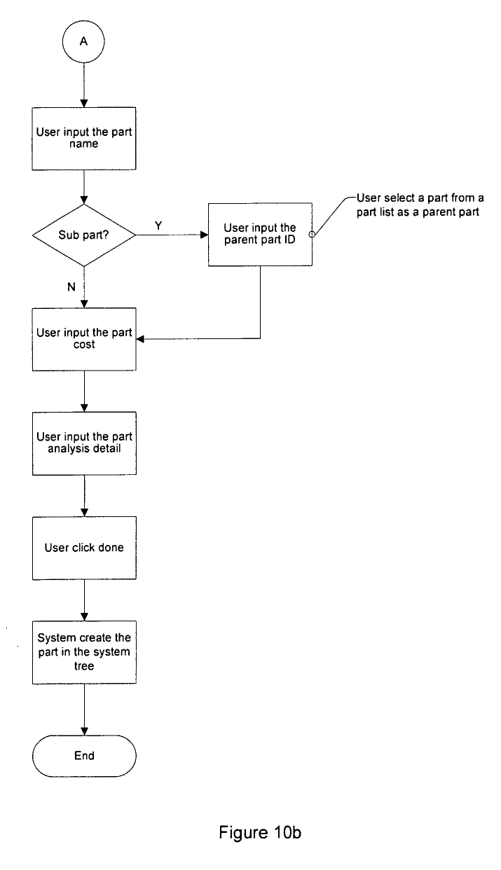

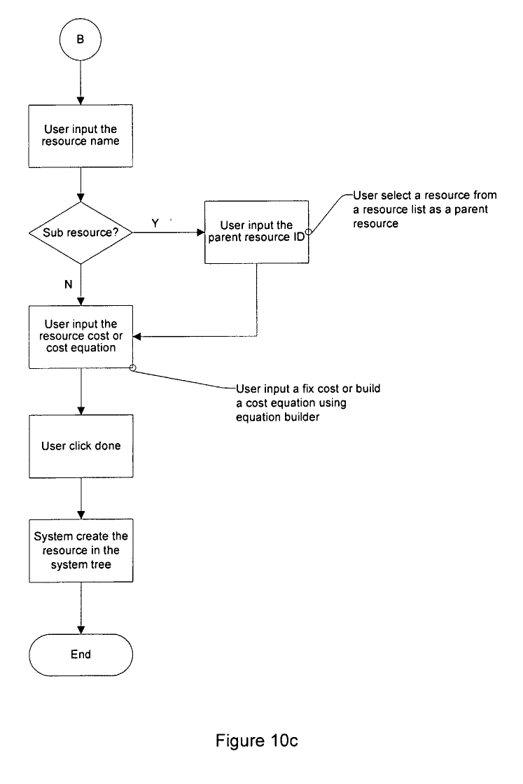

FIGS. 10a-10d illustrate the general flow of using a wizard or guide to assist the user with entering key information needed to successfully compile a system information model for analysis. The wizard or guide improves the speed and accuracy with which a user will compile a system information model for analysis.

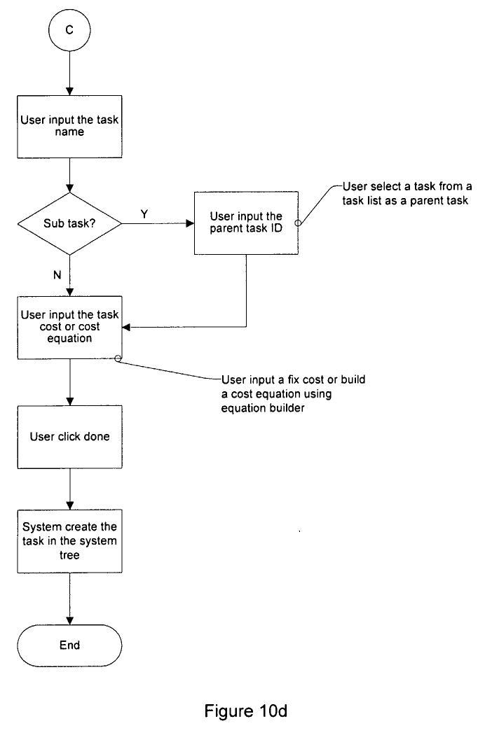

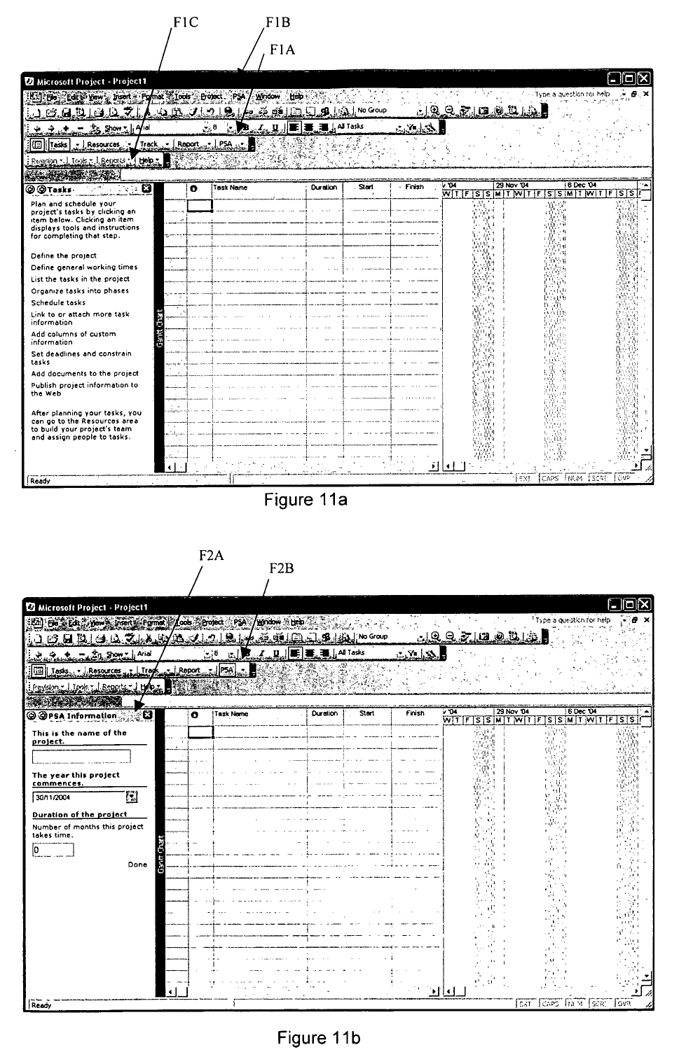

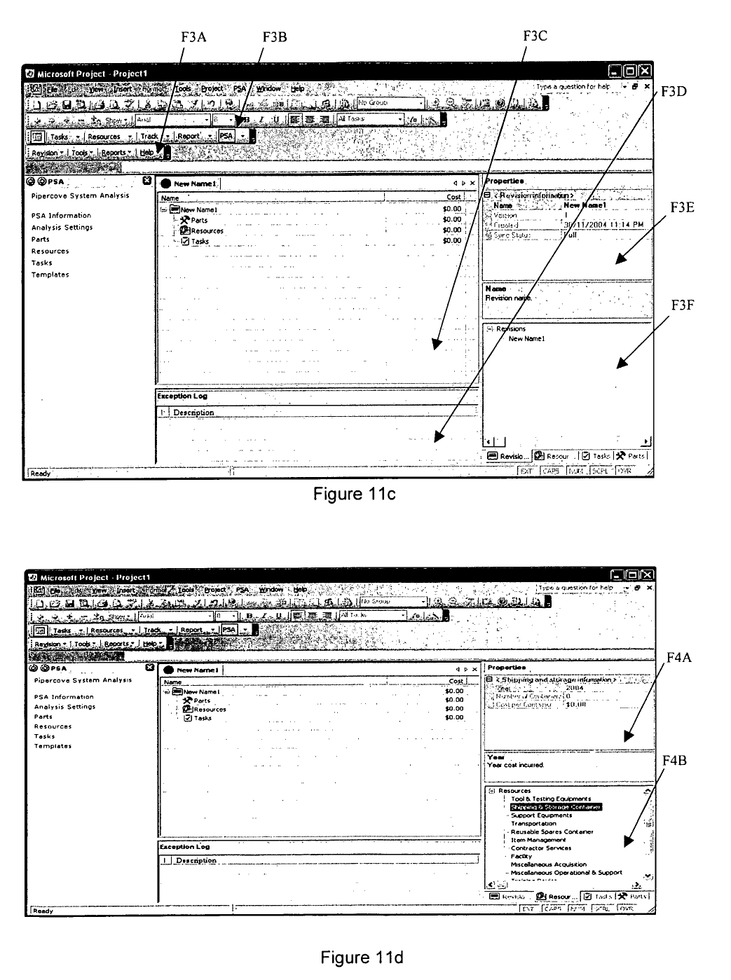

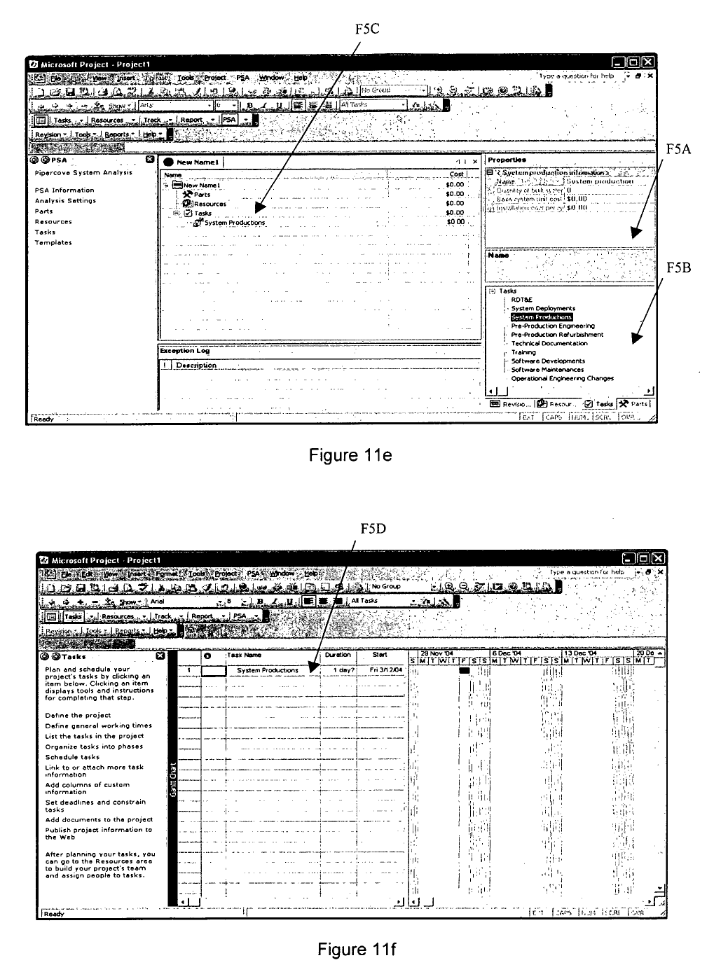

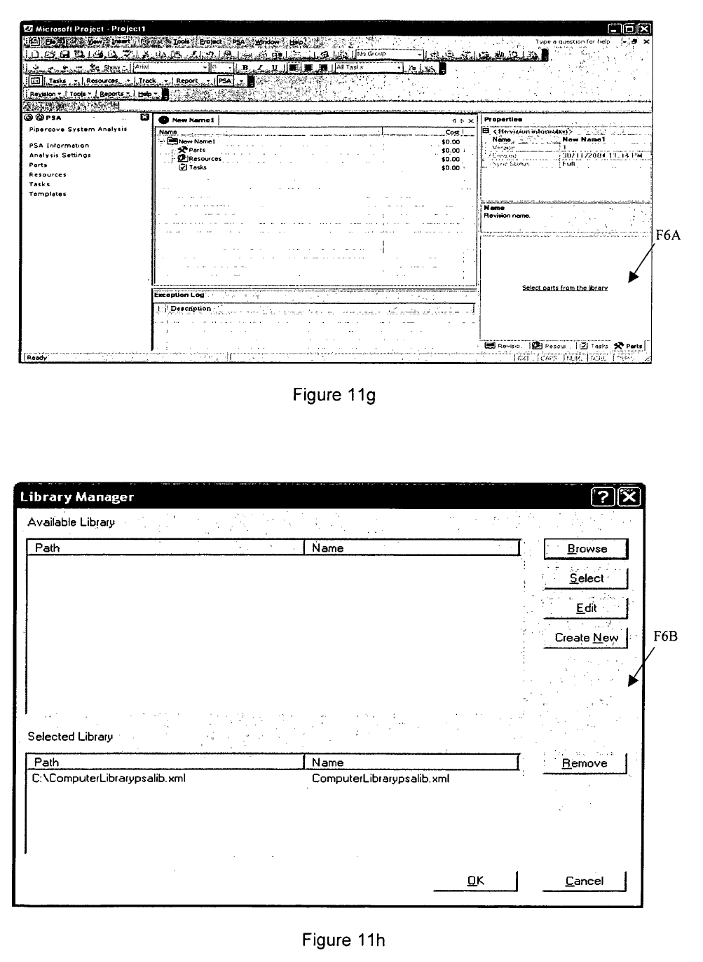

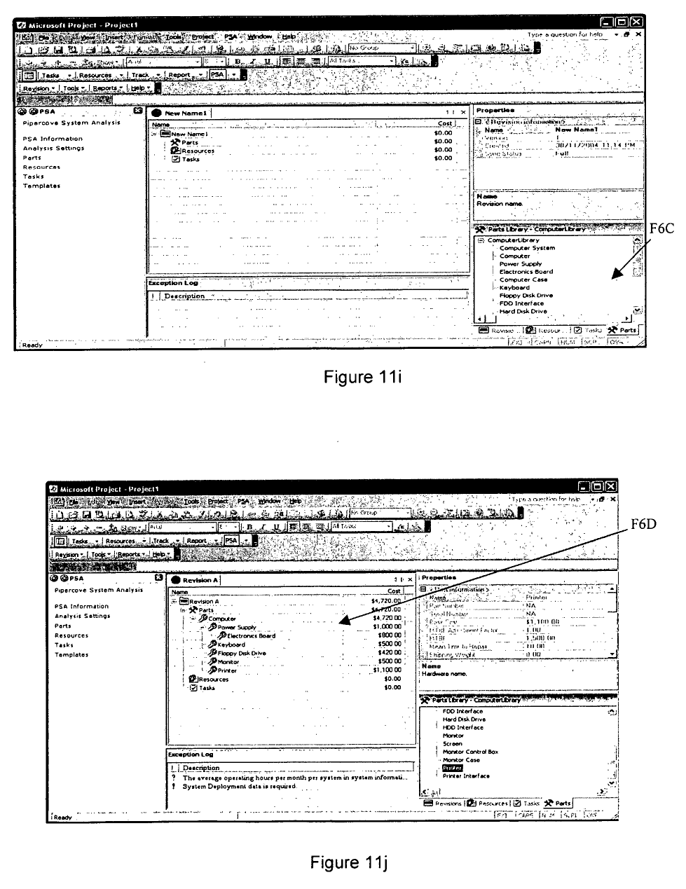

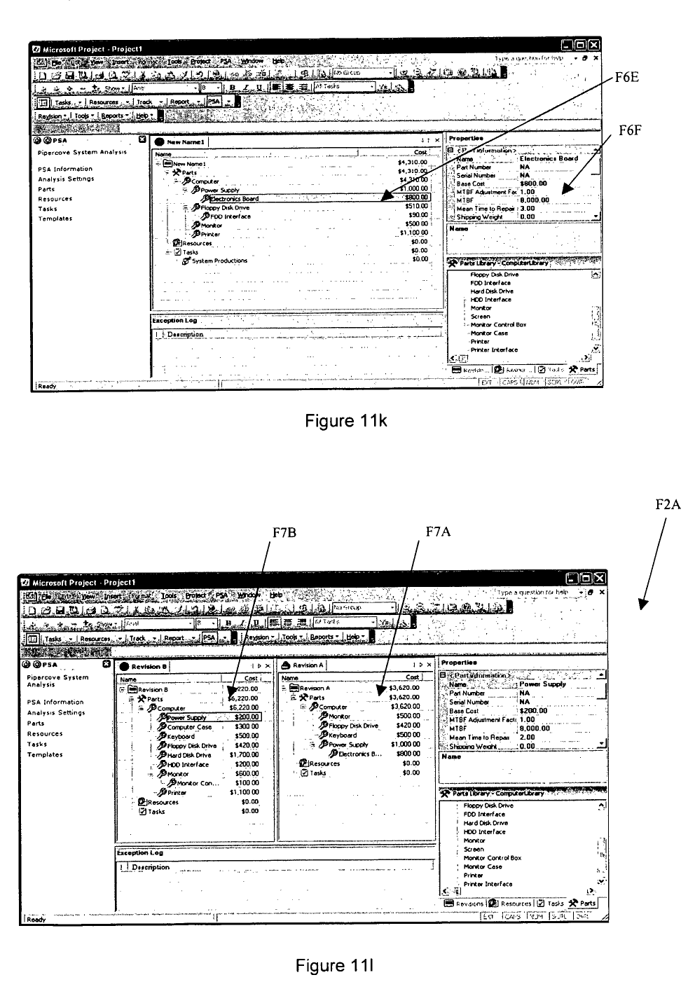

FIGS. 11a-11l illustrate sample screen shots of the SET 102 implemented as an add-in to Microsoft Project™. Referring to FIG. 11a, the SET 102 includes menu FIB, toolbar F1C and a wizard F1A to assist a user to input information while being guided through a logical process to ensure that minimum required information is input into the SET 102. The wizard F2A presents in a logical window questions and entry boxes for the user to enter information into the SET 102 when selected F2B, as illustrated in FIG. 11b. The wizard can be multi-page linked together as a number of steps.

As best seen in FIG. 11c, the SET 102 is a multi-window tool that permits the user to interact with the information in a logical way. The SET 102 provides for the user to customise the layout of the information windows and to opt to turn windows on or off as needed. When the SET 102 is active the toolbar F3A is active and may be displayed with any and all combinations of the following data entry and management windows: wizard menu F3B; system hierarchical view window F3C; ToDo list window F3D; version, system, component, activity properties window F3E; and utility window F3F.

Referring to FIG. 11d, the SET 102 includes a template of resources and tasks that can dragged and dropped onto the system. The items in the template can be varied to reflect an industry or equipment or system type. The template items are included in the utility window F4B, and when a template item is selected the properties are displayed in the properties window F4A.

FIG. 11e illustrates the SET 102 when the template of tasks is selected in the utility window F5C, and a task from the list is highlighted so that the properties for the task are displayed in the Properties window F5B, and the task has been added to the system F5A. The SET 102 includes automatic inclusion of this task (or resource) in the PMT 104 data and user interface F5D, as illustrated in FIG. 11f.

As illustrated in FIGS. 11g-11k, the SET 102 includes a component parts library that can be loaded into the utility window F6A using a parts library manager F6B which provides for more than one component part library to be open at any time from either a file or a SQL data source. The component parts are then displayed in the utility window F6C and can be dragged and dropped to form part of the system F6D. Their properties can be viewed or modified F6F using the properties window when a part is selected F6E in the system window. The system information model is updated and changed as any component part is added or changed.

FIGS. 11j-11l illustrate the capability of the SET 102 to compare versions of the system information model in a logical and easy to use way through the system view. The system versions can be made active, frozen or copied and worked on as subversions of frozen or active versions providing the capability for “what if” scenario analysis. FIGS. 11j-11l illustrate two versions of a system information model of a computer system that includes a computer and different constituent parts of the computer, together with peripherals including a printer. To identify particular information about one of the items shown in the hierarchical tree the user can select the item and the properties are displayed in the properties window F6E and F6F.

The illustrated embodiment 100 described above includes a number of functional blocks or modules that carry out data processing and interfacing actions to achieve the operations that provide the user with the capability to perform operations in the areas of systems engineering, including but not limited to risk management, life cycle costing, life cycle assessment, environmental impact, and activity based analysis. The illustrated embodiment 100 allows the SET 102 to be tightly, yet seamlessly, coupled to the PMT 104 so that the user who was not familiar with the SET 102 when first using the PMT 104 would not necessarily identify the SET 102 from its outward appearance due to it being implemented using the same look and feel as the PMT 104. As illustrated in FIGS. 11a-11l, the SET 102 is implemented, by way of non-limiting example only, as an add-in to Microsoft Project™ which includes the use of views (also known as groups of dockable windows within a window management framework), menus, toolbars, and wizards. By tightly coupling the look and feel of the SET 102 to the PMT 104, the user is able to use the SET 102 in the same manner as for any functional part or process of the PMT 104.

In use, the user opens a project using the PMT 104. The user can open a project that is local to the user's computer stored in a file or in a relational database. The user can also open a project that is made available to multiple users through a server system and relational database in a group co-operative approach where users are assigned roles and capabilities by an administrator.

If the project being opened is a new project or one that has not been opened by the SET 102 previously, the SET 102 will create a corresponding SET file or relational database store for the SET data objects, as illustrated in FIG. 1.

With an open project, the user can enter data through the PMT, SET or wizard, as illustrated in FIGS. 11a-11l. As discussed above, the purpose of the wizard is to provide the user with a step by step guided approach to entering key data into the SET and to being guided through the process of accessing library or templates and utilising the information, data objects or calculations and reports associated with the templates, as illustrated in FIG. 4, FIGS. 6a and 6b, FIGS. 7a-7c, and FIGS. 8a-g. The SET 102 also allows the user to select a template at any time whilst the SET 102 is active. The template will make available a library, calculations, reports and associated activities that are related to the template. The templates for reports and calculations to enable analysis of the system over the life cycle can, by way of non-limiting examples only, include life cycle costing, comparison, summation, monte carlo analysis, sensitivity analysis and deployment, maintenance, costs including annual and total and segmented and support rationale including requirements for spare parts and repair personnel. It will be appreciated that the templates and associated reports and calculations can include any and all conventional data structures, reports and calculations used in systems engineering in any and all industries or organisations.

The template capability of the SET 102 reduces the user's need to understand the complexities of systems engineering and associated activities under this umbrella. The user will be able to provide information or use the information provided through the library to construct the system information model, and will be able to calculate and report on systems engineering and associated activities under this umbrella. This will improve productivity and provide an opportunity for non-technical project managers to gain an indication of risk factors that would normally only be achievable through the use of specialised assistance and separate software applications. The template capability also reduces the time taken by the user to assemble the data objects and system design that make up the system information model. The user can also select other libraries to use in conjunction to the template assigned libraries. The user may opt to not use a template, and may wish to select libraries, calculations and reports on an as needed basis. As illustrated in FIGS. 11d-11l, more than one library can be opened at one time in the utility window. Using the utility window, the user can select between libraries such that one is active at a time.

The SET 102 carries out background computation as the user inputs information into the SET 102 or makes changes to the system information model through the PMT 104. For example, FIG. 11l illustrates the total cost of the system to be calculated and displayed in a column called “cost” F7A, F7B. It will be appreciated that this is but one example of the many background computations occurring in real time to provide the user with feedback and to identify items that require the user's attention by being placed in the ToDo list window F3D illustrated in FIG. 11c.

As illustrated in FIGS. 11i and 11j, the user selects parts, resources or tasks from the libraries F6C and places them into the system F6D to build up the parts and activities of the system information model. An activity is one or more tasks or resources that are either contiguous or non-contiguous in time. An example of an activity is system deployment. The system deployment activity might include all of the systems being deployed at one time, or it might provide for systems to be deployed over time in batches. In the PMT 104, each deployment action is a task. The activities provide a means to bring together similar tasks for the purpose of identification and calculation requirements. Another example of an activity is transportation, where a single activity and subsequent resource added to the PMT 104 or the SET 102 is used to reflect the use of transportation throughout the life of the system under study. This is necessary as there are many activities that are included in systems engineering analysis that are not broken down into the fine detail of individual tasks and resources as typically used in the PMT 104 but instead are identified as a single entity over time often the system life. To use the transportation example to show this, there may be 30 transportation actions carried out by a third party organisation per year. For the user's systems engineering analysis all that is needed is an activity identifying transportation and the properties such as who carries out the action, what is it, the total cost, cost variations and so on.

The user can create system component parts, activities, tasks and resources in the system window of the SET 102 or for tasks and resources in the PMT 104. The user can copy any new items created into the appropriate library and save the library if the user has the appropriate security permissions.

The user can select calculations to perform or end-user reports to generate. Information used in the calculations or reports can be collected from the SET 102 or PMT 104 and can be information from the data objects or computed collation of data objects, system assemblies or other activities. The system can include system assemblies. A system assembly is an item that is a collection of system component parts, such that the assembly parameters or properties reflect the aggregation of the component part parameters or properties.

The SET 102 also includes the capability to open and save the data objects, templates and libraries to file or relational database. The SET 102 will attempt to save information to the same data source as that in use by the PMT 104. If the PMT data source is not available due to access restrictions, capability or other reasons then the SET 102 will save the data to local file.

The SET 102 includes the logic to transform the input data into a form suitable for the calculations and reports for analysing the system over its life cycle. The SET 102 also includes a data interface that is able to identify the format of the data objects and to either transform the data object or to place an item in the ToDo list for the user's attention. An example of this is date formats, language settings and time zones. Date formats may include transformation between short and long dates. In general, the SET 102 will use the date, time zone, language and currency settings found in the current project under study through the PMT 104 or host settings.

The reporting, document creation, charting capability provided by the SET 102 are ultimately a means for the user to review current or future decision making in a number of areas, including system availability, environmental outcomes, financial and resource usage, and other key engineering and management decision areas.

It will be appreciated from the foregoing description that embodiments of the present invention act as an umbrella for risk management, system analysis and systems engineering techniques. Embodiments of the invention have application across most industries and markets to reduce development time, identify risk and life cycle changes, and improve the probability of system, product or service success.

Embodiments of the present invention allow a top-down functional approach to system design which involves creating and exploiting a hierarchical tree view of system components and related activities. When used in conjunction with a PMT, a user can selectively implement a system design using a bottom-up functional approach or partial top-down and bottom up by alternating between the PMT and SET views. Embodiments of the invention provide an interface for detailed information gathered from the user, the project management tool and a library or relational database of the system and activity components. Embodiments of the invention also provide system analysis, risk analysis, life cycle costing, life cycle assessment, reporting and library functionality to enhance a project management tool.

It will also be appreciated that embodiments of the invention provide engineers and project managers with an architecture and approach for the seamless integration of a PMT, which understands task, time, resource, and cost, with a SET that understands a system, its component parts and life cycle activities associated with the system. This integration is done in a way that ensures that the existing or legacy PMT is unaffected and will either operate standalone or in conjunction with the integrated SET. The actual integration of a PMT and SET using specialised software interfaces and techniques provides an enhanced and simplified environment for the user to achieve outcomes that encompass both project management and systems engineering processes.

Embodiments of the invention also provide a system component parts library by creating a standard template capability where the user can load, edit or add templates containing, resources, tasks, component parts or any of these as individual libraries. The provision of system version control and comparison in an easy to use manner enhances the user experience and provides a range of system comparison capability including differences between the system, activities, tasks, resources, time and cost and coalesced factors such as total cost, changes to critical path, systems engineering functions such as availability, reliability, net present value changes, risk management factors and other computations included under the umbrella of systems engineering and project management.

The functionality provided by embodiments of the invention is an amalgam of the activities that are normally carried out by project managers and engineers in the development and management of large, technically complex systems. These activities have become fundamental to the process of developing systems or products within many fields of endeavour. Attempts have been made to combine project management with other activities for the purpose of improving or simplifying the process of achieving the information necessary for a company to successfully achieve outcomes in a competitive world. The time to train project managers and engineers in a number of specialisations is expensive and the provision of more than one tool to carry out the functions adds to the complexity and cost of the task.

It will also be appreciated that embodiments of the invention remove or reduce the general limitations of conventional project management practices. Project management is an activity process that may occur for a few hours for a small project through to many years or even decades for large projects. There are a number of phases applied to projects and different project management methodologies use different terminology for the phases and are not uniform in phase length. Project management information is often not static—for example, costs change over time and the length of time to achieve a task may change. Typically reasonable project management tools provide for variability with respect to time by using a technique known as net present value and time and cost variability. Project management must also provide traceability. The public whether as interested parties to a public organisation or as shareholders of a public company are becoming increasingly interested in open governance. Problems still arise, projects still fail and people want to know why. Project managers and engineers need a simple mechanism to continue altering the information in a project plan over time, yet be able to go back to particular points in the project and be able to identify key decisions and key factors affecting major change in the project outcomes.

Against this background, embodiments of the invention provide an easy to use integrated functional approach to implement system analysis, risk analysis and system engineering (including, in particular, life cycle costing and life cycle assessment capability) with information provided by the user while using a PMT. The user may provide the information directly to the SET, or into the PMT whereby the SET will automatically update from the PMT.

Embodiments of the invention also provide means to implement top-down system analysis design or bottom-up system analysis design of the outcome of the project under study using the PMT. For example, the user may opt to use the SET prior to using the PMT, thereby creating the system using a top-down approach. Alternatively, the user may opt to use the PMT prior to using the SET, thereby creating the system using a bottom-up approach.

Embodiments of the invention are specifically designed to provide an interface that is inherently part of the PMT so as to simplify the learning required by the user to use the SET. For example, the system is displayed in a hierarchical tree in one window. When the user clicks on an item in the tree, the details of the item are displayed in another window. The user is able to display the system component parts library in another window and to add, edit or delete system component parts from the library. The user can drag the system component parts from the library window and drop them into the appropriate place in the system tree. The SET will then automatically carry out background tasks so as to reflect the changes to the system in both the SET and the PMT.

Embodiments are also specifically designed to provide means to input system information from either the PMT, from any information source used by the PMT, or from a system component parts library, database or XML information source. Embodiments provide access to system component information, activity information, computations and reports that provide project managers and engineers with information in the areas of system analysis, risk analysis and systems engineering (including, in particular, life cycle costing and life cycle assessment). Embodiments of the invention can either integrate into the project management application in the form of an add-in (or plug-in), or would be able to be run at the same time as the PMT where it is able to access and manipulate the project management applications data. In some scenarios, embodiments of the invention could therefore be run on a different computer to the project management application or the data source.

Embodiments of the invention also remove one of the flaws found in system engineering and project management tools by providing a means to freeze a copy of the system information model being project managed. Embodiments provide for the user to continue to work with either the copy or the frozen version of the system information model and to do comparisons between versions. Multiple versions can be frozen over time, thus providing for the current status of the project to be identified at the end of phases or as milestones are achieved over the life cycle.

It will be appreciated that the embodiments described above are intended only to serve as examples, and that many other embodiments are possible with the spirit and the scope of the present invention.

1. A method for integrating systems engineering and project management tools, the method including the steps of:
obtaining component parts and life cycle activities of a system;
creating a system information model by selectively and individually linking parts and activities with tasks, resources, time and costs;
updating the system information model by selectively and individually adding or modifying parts, activities, tasks, resources, time, costs and links therebetween;
storing versions of the system information model;
processing versions of the system information model into end-user information to enable life cycle analysis of the system.

2. A method according to claim 1, wherein the method is implemented as an add-in or plug-in to a project management application.

3. A method according to claim 2, wherein the project management application is at least one of Microsoft Project™, Artemis® and Primavera®.

4. A method according to claim 2 or 3, wherein the system information model accesses tasks, resources, time and costs from the project management application.

5. A method according to any preceding claim, wherein the system information model includes at least one of parts, activities, tasks, resources, time, costs and phases relating to at least one of requirements, definition, design, development, manufacturing, testing, deployment, operating, support, environmental impact, sustainability and decommissioning of the system.

6. A method according to any preceding claim, wherein the system information model and the end-user information are created and manipulated using libraries and templates.

7. A method according to claim 6, wherein the libraries and the templates are stored in files or a relational database.

8. A method according to claim 6 or 7, wherein the libraries include information relating to component parts, tasks, resources and life cycle activities of systems.

9. A method according to any one of claims 6 to 8, wherein the templates are expressed in eXtensible Markup Language (XML).

10. A method according to any preceding claim, wherein the step of processing versions of the system information model includes comparing different versions to provide traceability between iterations of the system over the life cycle.

11. A method according to any preceding claim, wherein the end-user information to enable analysis of the system over the life cycle includes information relating to at least one of systems engineering, project management, risk management, life cycle cost, life cycle assessment, environmental impact and system activities of the system project.

12. Computer software for integrating systems engineering and project management tools, the computer software residing on a computer-readable medium and including instructions for causing a computer to perform the following operations:
obtain component parts and life cycle activities of a system;
create a system information model by selectively and individually linking parts and activities with tasks, resources, time and costs;
update the system information model by selectively and individually adding or modifying parts, activities, tasks, resources, time, costs and links therebetween;
store versions of the system information model;
process versions of the system information model into end-user information to enable life cycle analysis of the system.

13. Computer software according to claim 12, wherein the computer software is an add-in or plug-in to a project management application.

14. Computer software according to claim 13, wherein the project management application is at least one of Microsoft Project™, Artemis® and Primavera®.

15. Computer software according to claim 13 or 14, wherein the system information model accesses tasks, resources, time and costs from the project management application.

16. Computer software according to any one of claims 12 to 15, wherein the system information model includes at least one of parts, activities, tasks, resources, time, costs and phases relating to at least one of requirements, definition, design, development, manufacturing, testing, deployment, operating, support, environmental impact, sustainability and decommissioning of the system.

17. Computer software according to any one of claims 12 to 16, wherein the system information model and the end-user information are created and manipulated using libraries and templates.

18. Computer software according to claim 17, wherein the libraries and the templates are stored in files or a relational database.

19. Computer software according to claim 17 or 18, wherein the libraries include information relating to component parts, tasks, resources and life cycle activities of systems.

20. Computer software according to any one of claims 17 to 19, wherein the templates are expressed in eXtensible Markup Language (XML).

21. Computer software according to any one of claims 12 to 20, wherein the step of processing versions of the system information model includes comparing different versions to provide traceability between iterations of the system over the life cycle.

22. Computer software according to any one of claims 12 to 21, wherein the end-user information to enable analysis of the system over the life cycle includes information relating to at least one of systems engineering, project management, risk management, life cycle cost, life cycle assessment, environmental impact and system activities of the system project.

23. A method for integrating systems engineering and project management tools, substantially as hereinbefore described with reference to the accompanying drawings.

24. Computer software for integrating systems engineering and project management tools, substantially as hereinbefore described with reference to the accompanying drawings.
